(19) United States
(12) Patent Application Publication
(10) Pub. No.: US 2012/0177967 A1
(43) Pub. Date: Jul. 12, 2012

(54) Battery case for portable electronic devices

(76) Inventor: Wen Fee Wang, Las Vegas, NV (US)

(21) Appl. No.: 12/930,403

(22) Filed: Jan. 6, 2011

(51) Int. Cl. H01M 2/10

(52) U.S. Cl. 429/100

(57) ABSTRACT

A battery case has a recessed space for receiving a portable electronic device. When the portable electronic device is placed in the battery case, a supplemental battery in the battery case is able to charge an original battery of the portable electronic device. The battery case has a first supplemental connector capable of being electrically coupled to an original inner connector of the portable electronic device, and a second supplemental connector exposed to the outside of the battery case. The second supplemental connector is configured to be compatible with an original outer connector of an original extension cable that comes with the original product package of the portable electronic device, such that the original outer connector can be inserted into the second supplemental connector of the battery case.

### BACKGROUND OF THE INVENTION

The present invention relates generally to a battery case, and more particularly to a battery case having at least one supplemental battery for charging portable electronic devices.

A battery case is a useful accessory that protects and enhances portable electronic devices, such as smart phones, mobile phones, cellular phones, satellite phones, MP3 players, potable DVD players, digital cameras, tablet computers, global positioning systems, portable game consoles, and other potable devices capable of processing digital information. The battery case is typically configured to include a space for receiving the portable electronic device. The case itself is made of materials capable of protecting the portable electronic devices from shocks, scratches, corrosive liquids, and physical impacts of foreign objects that might cause damages to the portable electronic devices. Such materials can include plastics, rubbers, composite materials, metals, and any other materials suitable for those functions. The battery case typically includes at least one supplemental battery for charging the original battery of the portable electronic device. When the portable electronic device is placed in the battery case, the female connector of the portable electronic device and the inner connector of the battery case form electrical contacts there between. The inner connector is electrically connected to at least one printed circuit board in the battery case, and the female connector is electrically connected to at least one printed circuit board in the portable electronic device. On the printed circuit boards, one or more control circuits might be provided for controlling and managing the process of charging or discharging the original battery and/or the supplemental battery. By placing the portable electronic device in the battery case, the supplemental battery of the battery case is electrically coupled to the original battery of the portable electronic device via the electrical paths established by the connectors and the printed circuit boards. As a result, the supplemental battery is able to charge the original battery under the control of the control circuits via the established electrical paths, when it has sufficient electric power to do so.

FIG. 1A illustrates a schematic top view of a typical portable electronic device 30 placed in a conventional battery case 10. The portable electronic device 30, for example, can be a smart phone that has a touch screen 32 for displaying visual images and receiving input commands. The portable electronic device 30 has a female connector 16 for receiving a male connector of its original extension cable (not shown in the figure) that comes with the original product package. At the other end of the original extension cable, there is another connector to be plugged into a variety of apparatuses for many different purposes. For example, it can be plugged into an adapter, which, in turn, is plugged into a power outlet for charging the original battery inside the portable electronic device 30. As another example, it can be plugged into a USB port of a computer for charging the original battery of the portable electronic device, and/or transferring data there between.

The battery case 10 includes a space generally matching the shape and size of the portable electronic device 30. In the space is an inner connector 22 that fits into the female connector 16 of the portable electronic device 30, when the portable electronic device 30 is placed in the space of the battery case 10. The battery case 10 typically includes a supplemental battery (not shown in this figure) placed inside the case, and electrically connected to the inner connector 22 via at least one printed circuit board (not shown in the figure). As the inner connector 22 fits into the female connector 16, electrical paths between the supplemental battery of the battery case and the original battery of the portable electronic device are established via the electrical contacts between the inner connector 22 and female connector 16, at least one printed circuit board of the battery case 10 electrically connecting the inner connector 22 to the supplemental battery, and at least one printed circuit board of the portable electronic device 30 electrically connecting the female connector 16 to the original battery. On the printed circuit board of the battery case 10 at least one control circuit is provided for controlling and managing the supplemental battery's charging the original battery of the portable electronic device 30 via the electrical paths established there between. Such conventional battery case design can be found, for example, in U.S. Pat. No. 7,782,610 to Diebel et al., entitled “Portable Electronic Device Case with Battery.”

As it is readily appreciated with reference to the figure, when the portable electronic device 30 is placed in the battery case 10, the female connector 16 is fully occupied by the inner connector 22, and therefore no longer available for use by the original extension cable. Conventionally, as shown in FIG. 1 B, an outer connector 18 with a reduced number of pins is embedded on a front wall of the battery case 10 for providing the portable electronic device 30 with limited access of signals. For example, in case where the portable electronic device 30 is an iPhone, a trademark identifying the smart phones made by Apple, Inc., the female connector 16 is provided with 30 pins covering a wide range of signals adapted to be transferred between the portable electronic device 30 and an external apparatus. However, in a typical, conventional battery case 10, the outer connector 18 is a female mini USB port or micro USB port, which offers only 5 pins for limited functions, such as data and power transferring. As a result, some important functions or capabilities of the portable electronic device 30 are lost. For example, in case where the portable electronic device 30 is an iPhone, the battery case 10 would not be able to output certain audio or video signals that can be received and processed by a speaker dock or high definition television, which otherwise would have been accessible by its original extension cable connected to the female connector 16.

Moreover, because the outer connector 18 of the battery case 10 is not compatible with the original extension cable of the portable electronic device 30, an additional extension cable (not shown in the figure) compatible with the outer connector 18 is needed in order to transfer data and power into and out of the portable electronic device 30 in the battery case 10. This renders the portable electronic device 30 less mobile and inconvenient. For example, when a person travels with the portable electronic device 30 in the conventional battery case 10, he or she needs to carry an extra extension cable for the outer connector 18 in addition to the original extension cable. This makes the travel not only inconvenient, but also unpleasant.

Due to the mechanical and electrical interfaces required between the inner connector 22 and the outer connector 18, the front portion of the battery case 10 needs to be lengthened in order to make room for those necessary interfaces. As a result, the battery case 10 is bulky, uncomfortable to carry, and most importantly unappealing. In a market where the compactness, lightness, and aesthetics of the portable electronic device are important factors in consumers' purchase decisions, a bulky battery case is likely to decrease the appeal of the portable electronic device, thereby disserving the users.

As such, what is needed is a battery case for a portable electronic device that is compact, slim, and light, without compromising on the functionality and capability offered by the original extension cable of the portable electronic device.

### BRIEF SUMMARY OF THE INVENTION

The present invention is directed to a battery case for a portable electronic device. In some embodiments of the invention, the battery case includes a first portion having a first back plate and a first sidewall together defining a recessed space for receiving the portable electronic device in a manner that an original inner connector of the portable electronic device is exposed to and accessible from an outside of the first portion; a supplemental battery placed on the first back plate in the recessed space; a second portion having a second back plate and a second sidewall, and being adapted to engage with the first potion, when the first portion and the second portion are engaged, the second sidewall aligning with the first sidewall, and the second back plate aligning with the first back plate; a first supplemental connector mounted on the second sidewall for establishing electrical contacts with the original inner connector when the portable electronic device is placed in the recessed space and the second portion is engaged with the first portion; and a second supplemental connector mounted on the second sidewall and having an opening for receiving an original outer connector of the portable electronic device, the second supplemental connector being compatible with the original outer connector and electrically coupled to the first supplemental connector, such that when the original outer connector is inserted into the opening of the second supplemental connector, the original outer connector is electrically coupled to the original inner connector via the first and second supplemental connectors.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1A illustrates a schematic, top view of a portable electronic device placed in a conventional battery case.

FIG. 1B illustrates a schematic, front view of the conventional battery case.

FIG. 2 illustrates a perspective view of a battery case in a disengaged position in accordance with some embodiments of the invention.

FIG. 3 illustrates a perspective view of a battery case with its supplemental battery and printed circuit board removed in accordance with some embodiments of the invention.

FIG. 4 illustrates a perspective view of a battery case in an engaged position in accordance with some embodiments of the invention.

FIG. 5 illustrates a front view of a portion of a battery case in accordance with some embodiments of the invention.

FIG. 6 illustrates a schematic diagram showing how the pins of the connectors of the battery case are electrically connected via a plurality of conductive traces in accordance with some embodiments of the invention.

FIG. 7 illustrates a functional diagram showing the interconnections of a battery case, portable electronic device, and external apparatus in accordance with some embodiments of the invention.

FIG. 8 illustrates a schematic, cross-sectional view of the internal components of a conventional battery case.

FIG. 9 illustrates a schematic, cross-sectional view of the internal components of a battery case in accordance with some embodiments of the invention.

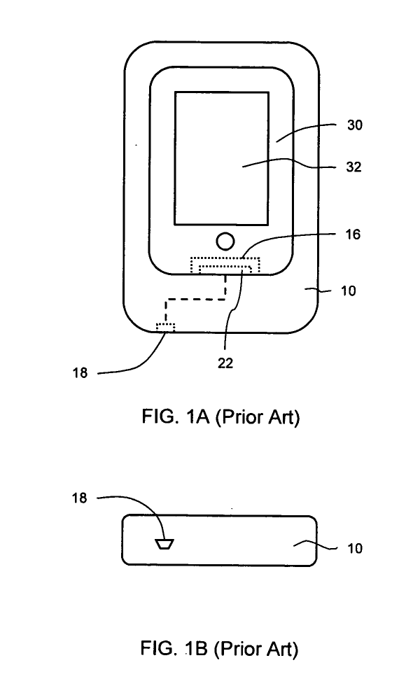

### DETAILED DESCRIPTION OF THE INVENTION

The present invention is directed to a battery case for portable electronic devices. In some embodiments of the invention, the battery case has a recessed space in which the portable electronic device can be placed. When the portable electronic device is placed in the battery case, a supplemental battery in the battery case is able to charge an original battery in the portable electronic device. The battery case has a first supplemental connector capable of being electrically coupled to an original inner connector of the portable electronic device, and a second supplemental connector exposed to the outside of the battery case. The second supplemental connector is configured to be compatible with an original outer connector of an original extension cable that comes with the original product package of the portable electronic device, such that the original outer connector can be inserted into the second supplemental connector, thereby establishing electrical contacts there between. As a result, when the portable electronic device is placed in the battery case, its original extension cable can still be used for transferring data and electrical power between the portable electronic device and an external apparatus. Specific and detailed examples and embodiments of the invention are described below with reference to accompanying drawings.

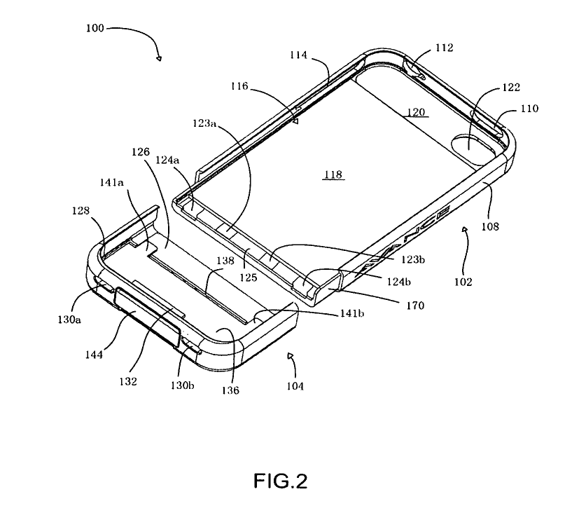

FIG. 2 illustrates a perspective view of a battery case 100 for a portable electronic device in accordance with some embodiments of the invention. The portable electronic device can be a smart phone, mobile phone, cellular phone, satellite phone, MP3 player, potable DVD player, digital camera, tablet computer, global positioning system, portable game console, and any other potable device capable of processing digital information. Among a wide variety of applications, the battery case 100 is particularly useful in protecting a smart phone from damages caused by external forces, such as an accidental drop to the ground. The battery case also provides the smart phone with a supplemental battery as a back-up power supply. Examples of popular smart phones available on the market include Apple iPhone and other smart phones that have the female connector placed at one of the longitudinal ends thereof. With little variation in the scope of the invention, the battery cases 100 can accommodate those smart phones available on the market.

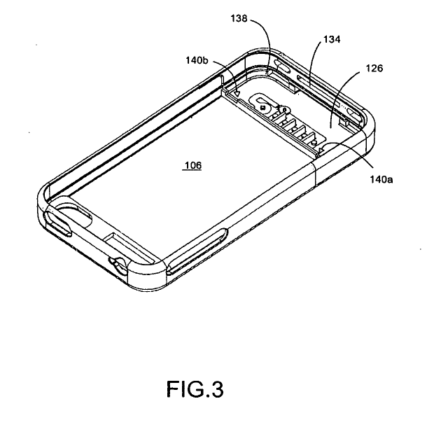

The battery case 100 includes a first portion 102 and a second portion 104 that can be separated from or engaged with one another. The first portion 102 includes a first back plate 106, which can be viewed from a clearer angle with reference to FIG. 3, and a first sidewall 108 having a U-shaped configuration extending around the edges of the first back plate 106. The top edge of the first sidewall 108 is inwardly inclined for securing a portable electronic device (not shown in the figure) inserted into the first portion 102. A number of openings 110, 112 and 114 are formed on the first sidewalls 108 for providing access to the control buttons and microphone/speaker sockets of the portable electronic device. For example, the opening 110 provides access to the on/off button of the portable electronic device, the opening 112 allows a microphone/speaker jack to be inserted into the microphone/speaker socket of the device, and the opening 114 exposes the volume control button of the device to the outside of battery case 100.

The exact number and locations of such openings may vary from embodiment to embodiment to accommodate different portable electronic devices. For example, the opening 112 can be placed on the bottom-right segment of the first sidewall 108, instead of the up-right segment, to accommodate a portable electronic device having a microphone/speaker socket on its longitudinal side. In some other embodiments, the opening 110 can be eliminated altogether for some portable electronic devices may have their on/off button on their display panel, instead of on the side.

The first sidewall 108 and the first back plate 106 define a recessed space 116 for receiving a supplemental battery 118. The supplemental battery 118 is a rechargeable battery that can be recharged by a power outlet, and functions as a power supply to charge the original battery inside the portable electronic device. The supplemental battery 118 can be a typical lithium ion rechargeable battery, or other types of suitable rechargeable battery. The supplemental battery 118 is configured to have a capacity ranging approximately from 2 to 40 Wh. The shape and size of the supplemental battery 118 match the inner dimensions of the first back plate 106, such that the supplemental battery 118 can be stably secured in the recessed space 116.

The electrodes 123a and 123b of the supplemental battery 118 is disposed at an end of the first portion 102 facing the second portion 104. The electrodes 123a and 123b are electrically connected to electrical contact elements 124a and 124b, respectively, via interconnections embedded on a printed circuit board 125. At least one control circuit (not shown in the figure) is provided on the printed circuit board 125 for overcharge protection and shut off. The electrical contact elements 124a and 124b can be made in various configurations. For example, the electrical contact elements 124a and 124b are a pair of conductive leaf springs capable of forming and maintaining electrical contacts with external conductors by a spring force. In other alternative examples, the electrical contact elements 124a and 124b can be configured into coil springs or bumps made of conductive materials. In yet other alternative examples, the electrical contact elements 124a and 124b can simply be two thin layers of conductive coating.

A spacer 120 is placed between the supplemental battery 118 and the first sidewall 108 in a longitudinal direction. The spacer 120 has an opening 122 in alignment with a lens and/or flashlight of a camera built in the portable electronic device placed in the battery case 100, thereby enabling the camera to capture images through the lens exposed by the opening 122.

In alternative embodiments of the invention, the spacer 120 may be a solid block of material without any embedded openings, which is suitable for the portable electronic devices without any built-in cameras. In some other alternative embodiments, the entire spacer 120 can be eliminated to make room for an elongated supplemental battery 118.

The second portion 104 includes a second back plate 126, and a second sidewall 128 having a U-shaped configuration extending around the edges of the second back plate 126. The top edge of the second sidewall 128 is inwardly inclined for securing a portable electronic device inserted into the first portion 102 when the first and second portions 102 and 104 are engaged. A number of openings 130a and 130a are formed on the second sidewalls 128 for enabling sound produced by the portable electronic device to travel through the second sidewall 128.

A first supplemental connector 132 is mounted on the inner side of the second sidewall 128 for establishing electrical contacts with an original inner connector (not shown in the figure) of the portable electronic device placed in the recessed space 116, when the second portion 104 is engaged with the first portion 102. The first supplemental connector 132 is configured to be compatible with the original inner connector of the portable electronic device, not only in their shapes, but also in the layouts of their pins. When the first supplemental connector 132 is inserted into the original inner connector, the pins of the first supplemental connector 132 form electrical contacts with respective pins of the original inner connector.

The first supplemental connector 132 can be any male connector suitable for plugging into the female connector of a portable electronic device. Examples of the first supplemental connector 132 includes any proprietary connectors for smart phones, such as Apple iPhone, and other smart phones that have the female connector placed at a longitudinal end thereof. In some embodiments, the first supplemental connector 132 is configured to establish electrical contacts with all of the pins of the proprietary connector. For example where the proprietary connector is an iPhone connector, the first supplemental connector 132 can have a total pin count of 30, matching the 30 pins of the iPhone connector. In some other preferred embodiments, the first supplemental connector 132 has a reduced number of pins configured to establish electrical contacts with only a desired few of the pins of the proprietary connector. For example where the proprietary connector is an iPhone connector, the first supplemental connector 132 can have a total pin count of only 8 configured to be in contact with only the desired ones among the 30 pins of the iPhone connector. This makes the design and manufacturing of the supplemental connector 132 and its supporting circuitry simple, while selectively keeping the important functions offered by the proprietary connector available.

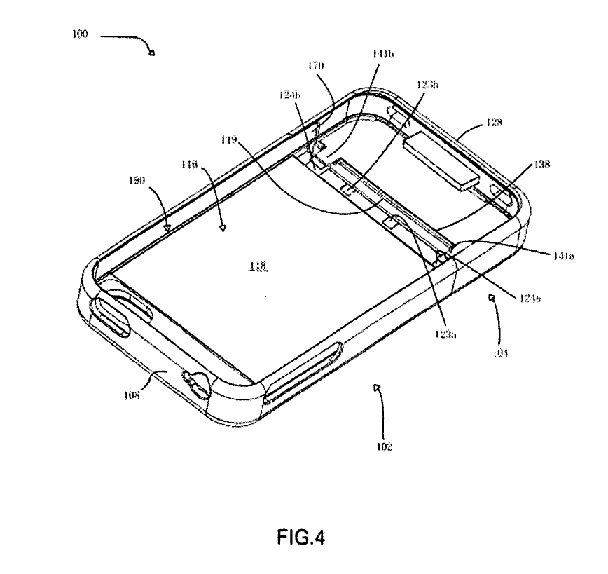

There are many methods by which the first supplemental connector 132 can be mounted on the second sidewall 128. For example, the first supplemental connector 132 can be mounted on the second sidewall 128 by tightly fitting through an opening 134, which can be viewed from clearer angles with reference to FIGS. 3 and 4. In an alternative example, adhesive can be applied between the first supplemental connector 132 and the inner surface of the opening 134 to better secure the first supplemental connector 132 to the second sidewall 128.

A printed circuit board 136 is placed on a protrusion element 138, which can be viewed from a clearer angle with reference to FIG. 3, in which the supplemental battery 118 and the printed circuit board 136 are removed for a better view of the first back plate 106 and second back plate 126. The protrusion element 138 is disposed on the second back plate 126 and extends around the inner edges of the second sidewall 128. The segment of the protrusion element 138 adjacent to the first portion 102 is configured into a straight wall, on which are formed two indentations 140a and 140b. The printed circuit board 136 has two tabs 141a and 141b resting on the respective indentations 140a and 140b, and extending beyond the straight segment of the protrusion element 138.

FIG. 4 illustrates the battery case 100 where the first and second portions 102 and 104 are engaged. In the engaged position, the first sidewall 108 aligns with the second sidewall 128, the first back plate 106 aligns with the second back plate 126, and a protrusion element 119 of the first portion 102 meets the protrusion element 138 of the second portion 104. As shown in the figure, in the engaged position, the tabs 141a and 141b of the printed circuit board 136 are in electrical contacts with the electrical contact elements 124a and 124b, which, in turn, are electrically connected to the electrodes 123a and 123b of the supplemental battery 118, respectively, via the interconnection on the printed circuit board 125.

The first portion 102 has a flange 170 protruding from an end of the first sidewall 108 in a longitudinal direction. The flange 170 matches a groove defined by the inner surface of the second sidewall 128. In an engaged position, the flange 170 slides into the groove, such that the relative positions of the first and second portions 102 and 104 are maintained by the frictional force between the flange 170 and the groove.

There are various ways of forming the flange and groove. In some embodiments of the invention, only one flange protruding from one of the two longitudinal arms of the U-shaped first sidewall 108 is enough to hold the first and second portions 102 and 104 in the engaged position. In other embodiments, there can be two flanges protruding from both longitudinal arms of the U-shaped first sidewall 108, in which the length of the two flanges may or may not be the same. In some other embodiments, the flanges can be constructed on the second portion 104, or one on the first portion 102 and the other on the second portion 104, depending on design choices.

Such designs provide flexibility and easy access to the original inner connector of the portable electronic device. The portable electronic device can be inserted into the first portion 102, while the second portion 104 is disengaged from the first portion 102. In this arrangement, the original inner connector of the portable electronic device becomes directly accessible. For example where the portable electronic device is an iPhone and the battery case 100 is configured to output only a selected few of the signal lines, such as audio lines, audio switch lines, power lines, data transfer lines, etc., offered by the original 30-pin iPhone connector, the removal of the second portion 104 enables direct access to the original iPhone connector, which may offer additional signal lines, such as high definition televisions lines, etc., while keeping most of the iPhone under protection of the first portion 102 of the battery case 100.

Although the battery case 100 is illustrated as having two portions engaged with one another, in some alternative embodiments of the invention, it is possible that the battery case is constructed by three or more separate portions, which, when engaged, form a space for receiving a portable electronic device. Although the first and second sidewalls 108 and 128 are illustrated in a U-shaped configuration, in some other alternative embodiments of the invention, other configurations might be used. For example, in some embodiments, the round corners of the first or second sidewall 108 or 128 might be modified into square corners. Alternatively, in some other embodiments, the engaged first and second sidewalls 108 and 128 can form an oval, circular, polygonal, or irregular configuration, depending on design choices.

A track 190 is formed on the inner surface of the first sidewall 108 for supporting and positioning the portable electronic device in the recessed space 116. The supplemental battery 118 is configured to be slim enough such that when the supplemental battery 118 is placed in the recessed space 116, the top surface of the supplemental battery 118 falls beneath the track 190. When the portable electronic device is placed in the recessed space 116, it sits on and is mostly supported by the track 190. A sheet of flexible material (not shown in the figure) can be placed on top of the supplemental battery 118 to conceal it from pain view as well as to provide additional support for the portable electronic device, which is particularly useful in absorbing shocks in the event of impact.

In some embodiments of the invention, the track 190 can be a continuous structure extending along the inner surface of the first sidewall 108. In some other embodiments of the invention, the track 190 is constructed by several pieces of separate structures extending along the inner surface of the first sidewall 108 and having an equal distance from the first back plate 106.

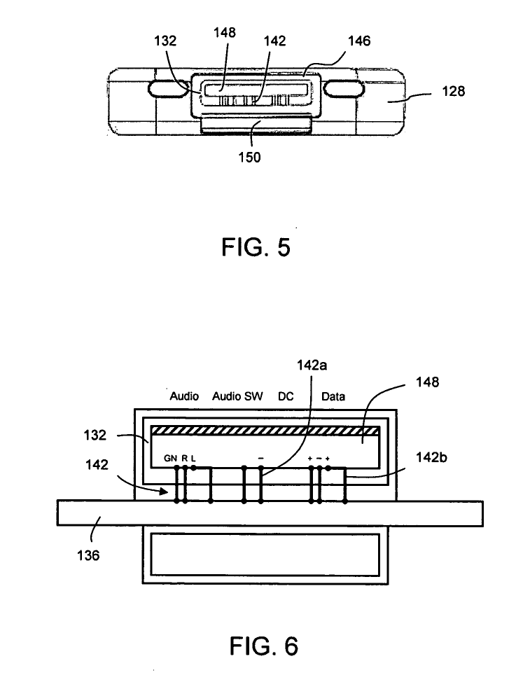

The pins in the first supplemental connector 132 are electrically connected to the printed circuit board 136 via a plurality of conductive traces 142 as shown in FIG. 5, which illustrates a front view of the second portion 104 with a front shield 144 (shown in FIG. 2) removed from the second sidewall 128. As shown in FIG. 5, an area 146 of the second sidewall 128 and the back end of the first supplemental connector 132 are visible when the shield 144 is removed. The first supplemental connector 132 is configured to include a slot 148 extending from its back end to the front end in a direction perpendicularly into the paper on which FIG. 5 is drawn. There are a plurality of pins in the slot 148 that are not readily visible from the drawing. These pins carry signals designated for specific functions, such as electrical ground, audio lines, audio switch lines, power lines, and data lines, etc. The conductive traces 142 are electrically connected to respective pins in the slot 148 at one end and respective nodes (not shown in the figure) on the printed circuit board 136 at the other end. These nodes are further electrically connected to their respective pins in a second supplemental connector 150.

The removal of the shield 144 is useful for machines and operators to access to the inside of the first supplemental connector 132, and lay out the conductive traces 142 from the inside of the first supplemental connector 132 to the printed circuit board 136, during manufacturing of the battery case 100. After the manufacturing is completed, the shield 144 is attached to the second sidewall 128 for covering the area 146. The attachment is preferably permanent, while in some embodiments it might be temporary and removable.

FIG. 6 illustrates an enlarged view showing how the conductive traces 142 are connected to the printed circuit board 136. As shown in the figure, there are 8 conductive traces, from the left to the right, designated as electrical ground, right audio signal line, left audio signal line, audio switch line, negative power line, positive power line, negative data line, and positive data line. As such, the first supplemental connector 132 provides selected functions of audio signal outputs, power access, and data transfer, but might not support other functions provided by the original connector of the portable electronic device. It is, however, noted that the number of functions selected and supported by the battery case 100 is a design choice, and in some other embodiments of the invention, the battery case 100 can be configured to support all or other selected numbers of the functions provided by the portable electronic device.

There are various routing options for connecting the conductive traces 142 to the printed circuit board 136. For example, the conductive trace 142a extends straight down from the bottom edge of the slot 148 to the printed circuit board 136. In some locations where two neighboring pins in the slot 148 are too close for the conductive traces 142 to extend straight down to the printed circuit board 136, one of the pins can have an L-shaped routing to avoid unexpected and undesirable short circuit. For example, the conductive trace 142b is configured in an L-shaped routing in which the traces extends horizontally in parallel with the printed circuit board 136 at the bottom edge of the slot 148, and then vertically down to the printed circuit board 136. In some alternative embodiments of the invention, the conductive traces 142 can be routed in other configurations not shown in the figure. For example, the conductive traces 142 can extend in an angled direction with respect to the bottom edge of the slot 148. In another example, the conductive traces can have many twists and turns before reaching the printed circuit board 136.

Referring back to FIG. 5, the second supplemental connector 150 is preferably a female connector as opposed to the first supplemental connector 132, which is preferably a male connector. The second supplemental connector 150 is configured to be compatible with the original outer connector of the original extension cable of the portable electronic device. When the original outer connector is inserted into the second supplemental connector 150, the pins in the original outer connector form electrical contacts with respective pins in the second supplemental connector 150. As a result, the pins of the original outer connector are electrically coupled to respective pins of the first supplemental connector 132 via the second supplemental connector 150 and the printed circuit board 136. When the portable electronic device is placed in the battery case 100 and the first supplemental connector 132 is inserted into the original inner connector of the device, the pins of the original outer connector are further coupled to respective pins of the original inner connector via electrical contacts between the first supplemental connector 132 and the original inner connector.

The original outer connector is preferably a male connector at one end of the original extension cable that comes with the product package of the portable electronic device. The other end of the extension cable is usually a connector with a different configuration from the original outer connector. For example in case where the portable electronic device is an iPhone, the original outer connector can be the 30-pin proprietary connector developed by Apple, Inc. and the other connector can be an USB connector, mini USB connector, micro USB connector, power plug, or any other connectors.

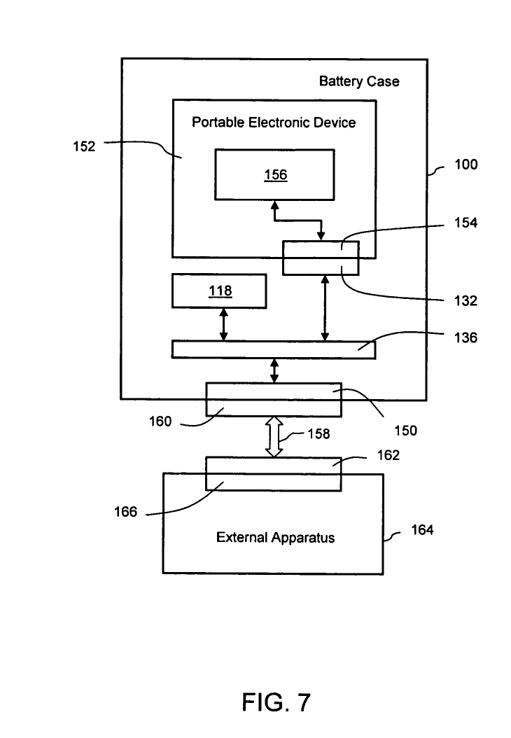

FIG. 7 illustrates a schematic view showing the interconnections among various connectors of the portable electronic device 152 and battery case 100 in accordance with some embodiments of the invention. When the portable electronic device 152 is physically placed in the battery case 100, the original inner connector 154 of the portable electronic device 152 is electrically connected to the first supplemental connector 132 of the battery case 100. The first supplemental connector 132 is electrically connected to the printed circuit board 136, which is further electrically connected to the second supplemental connector 150 and the supplemental battery 118. At least one control circuit is provided for controlling and managing the process of charging or discharging the supplemental battery 118. The control circuit can be programmed such that the functions of portable electronic device 152 accessible via the battery case 100 can be selected. If the supplemental battery 118 contains sufficient power, subject to a user's determination and selection, it can charge the original battery 156 of the portable electronic device at a predetermined voltage, such as 5 volts, via the electrical paths established by the printed circuit board 136, first supplemental connector 132, and the original inner connector 154.

The second supplemental connector 150 is adapted to be connected to an external apparatus 164 via an original extension cable 158 that comes with the original product package of the portable electronic device 152. The original extension cable 158 has an original outer connector 160 at one end, and another connector 162 adapted to be plugged into a socket 166 of the external apparatus 164 at the other end. The original outer connector 160 can be directly inserted into the original inner connector 154 and establish electrical contacts there between. The second supplemental connector 150 is configured to be compatible with the original outer connector 160, such that the original outer connector 160 can be inserted into the second supplemental connector 150 as well and establish electrical contacts there between. The other connector 162 of the extension cable 158 can be inserted into the socket 166 and establish electrical contacts there between. The external apparatus 164 can be a computer, power supply, power outlet on the wall, smart phone, mobile phone, cellular phone, satellite phone, MP3 player, potable DVD player, digital camera, global positioning system, game console, speaker dock, printer, scanner, and many other devices.

In case where the external apparatus 164 is a power supply or power outlet, the external apparatus 164 can charge both the supplemental battery 118 and original battery 156. The order of charging can be configured in different ways. For example, in some embodiments of the invention, the battery case 100 is configured such that the external apparatus 164 charges the original battery 156 first and then the supplemental battery 118 after the original battery 156 is completely charged. Alternatively, the battery case 100 is configured such that the external apparatus 164 charges the supplemental battery 118 first, and then the original battery 156 after the supplemental battery 118 is completely charged. In yet other alternative embodiments of the invention, the battery case 100 is configured such that the external apparatus 164 charges the supplemental battery 118 and original battery 156, simultaneously.

In case where the external apparatus 164 is a device with digital processing capability, such as a computer. The electrical signal path established via the original extension cable 158 and the battery case 100 enables data and power to be transferred between the portable electronic device 152 and the external apparatus 164.

The battery case 100 according to various embodiments of the invention enables a user to use only the original extension cable 158 to directly connect the portable electronic device 152 placed in the battery case 100 to any suitable external apparatus 164, thereby eliminating the need of carrying an additional extension cable required by a conventional battery case. This enhances the portability of the battery case 100, and makes it much more convenient to use.

Moreover, because a conventional battery case replaces the original connector with a mini USB connector or micro USB connector, many functions offered by the original connector are lost. For example, if a person wants to connect a smart phone to a speaker dock or high definition television, he or she will need to remove the phone from the conventional battery case completely, because the mini USB connector or micro USB connector does not have dedicated pins for audio/video signal outputs. In the present invention, the portable electronic device can be connected to the speaker dock without being removed from the battery case. The disclosed battery case enables the portable electronic device to be used as if there is no such battery case, while providing the benefits of extended battery time and physical protection. The disclosed battery case does not require users to change their behaviors, whereas conventional battery cases require users to adapt to them in a less intuitive manner.

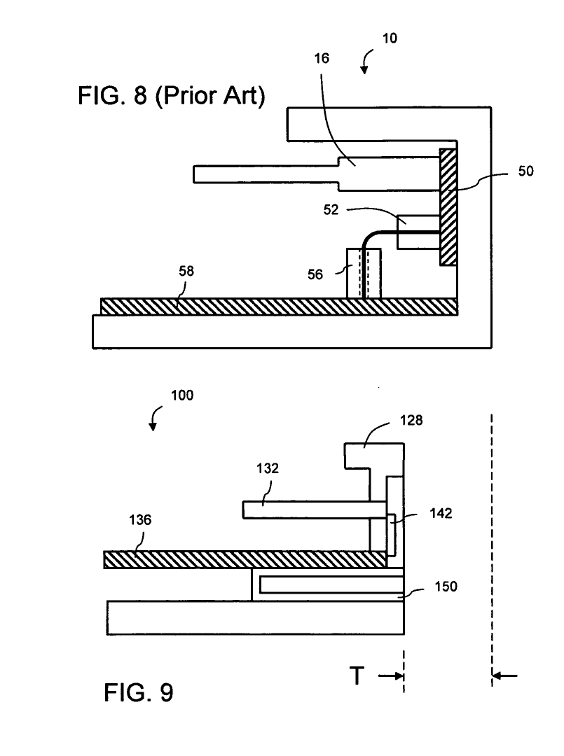

FIG. 8 illustrates a schematic, cross-sectional view of the arrangement of components in a conventional battery case 10. As shown in the figure, the inner connector 16 is coupled to a printed circuit board 58 via a printed circuit board 50 mounted on the sidewall, a male connector 52 on the board 50, and a female connector 56 on the board 58.

FIG. 9 illustrates a schematic, cross-sectional view of the arrangement of components in the battery case 100 in accordance with some embodiments of the invention. As discussed above, the first supplemental connector 132 is attached to the second sidewall 128, and electrically connected to the printed circuit board 136 via conductive traces 142. Comparing the disclosed battery case 100 to the conventional battery case 10, the disclosed battery case 100 is shorter by a distance T, as it eliminates the printed circuit board 50, male connector 52, and female connector 56. Moreover, the second supplemental connector 150 is disposed at an opposite side of the printed circuit board 136 to the first supplemental connector 132, and in vertical alignment with the same. As a result, the disclosed battery case 100 can be made a lot shorter, thinner, and more compact than the conventional battery case 10. This enhances the appeal of the battery case 100 as a compact and light weight design. It also makes carrying the battery case 100 around a lot more enjoyable and easier.

The above illustration provides many different embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A battery case for a portable electronic device, comprising:
a first portion having a first back plate and a first sidewall together defining a recessed space for receiving the portable electronic device in a manner that an original inner connector of the portable electronic device is exposed to and accessible from an outside of the first portion;
a supplemental battery placed on the first back plate in the recessed space;
a second portion having a second back plate and a second sidewall and being adapted to engage with the first potion, when the first portion and the second portion are engaged, the second sidewall aligning with the first sidewall, and the second back plate aligning with the first back plate;
a first supplemental connector mounted on the second sidewall for establishing electrical contacts with the original inner connector when the portable electronic device is placed in the recessed space and the second portion is engaged with the first portion; and
a second supplemental connector mounted on the second sidewall and having an opening for receiving an original outer connector of the portable electronic device, the second supplemental connector being compatible with the original outer connector and electrically coupled to the first supplemental connector, such that when the original outer connector is inserted into the opening of the second supplemental connector, the original outer connector is electrically coupled to the original inner connector via the first and second supplemental connectors.

2. The battery case of claim 1, wherein the second sidewall comprises an opening into which the first supplemental connector is fitted, thereby securing the first supplemental connector on the second sidewall.

3. The battery case of claim 2 further comprising adhesive between the first supplemental connector and the opening of the second sidewall.

4. The battery case of claim 2 wherein when the supplemental battery is placed in the recessed space and the second portion is engaged with the first portion, the first supplemental connector is inserted into the original inner connector of the portable electronic device, thereby enabling the second sidewall to be closely adjacent to the portable electronic device, without any substantial gap there between.

5. The battery case of claim 1 further comprising a printed circuit board electrically coupled to the first supplemental connector, the second supplemental connector, and the supplemental battery, when the first portion is engaged with the second portion, on the printed circuit board there being a control circuit for managing a process of charging or discharging the supplemental battery, and for selectively making a predetermined set of functions of the portable electronic device accessible by the battery case.

6. The battery case of claim 5 further comprising multiple conductive traces for electrically connecting respective pins in the first supplemental connector to respective nodes on the printed circuit board.

7. The battery case of claim 6 wherein at least one of the conductive traces comprises a horizontal segment substantially in parallel with the printed circuit board and a vertical segment substantially perpendicular to the printed circuit board.

8. The battery case of claim 6 wherein the nodes on the printed circuit board are electrically connected to respective pins in the second supplemental connector.

9. The cattery case of claim 6 wherein the printed circuit board is placed in the second portion, and has at least one tab for electrically connecting the printed circuit board to the supplemental battery, when the supplemental battery is placed in the recessed space, and the first portion and the second portion are engaged, the tab forms an electrical contact with at least one electrical contact element, which is further electrically coupled to at least one electrode of the supplemental battery.

10. The battery case of claim 9 wherein the at least one electrical contact element is configured as a leaf spring, coil spring, or bump.

11. The battery case of claim 6 wherein the first supplemental connector and the second supplemental connector are disposed at opposite sides of the printed circuit board.

12. The battery case of claim 6 further comprising a area on the second sidewall for providing an access for laying out the traces from the inside of the first supplemental connector to the printed circuit board during manufacturing of the battery case.

13. The battery case of claim 12 further comprising a shield attached to an outer surface of the second sidewall for covering the area after the manufacturing is completed.

14. The battery case of claim 6 wherein the second portion comprises at least one protrusion element on the second back plate for supporting the printed circuit board and creating a space for placing the second supplemental connector between the printed circuit board and the second back plate.

15. The battery case of claim 1 wherein the first sidewall comprises a track for supporting and positioning the electronic portable device in the first portion.

16. The battery case of claim 15 further comprising a sheet placed between the portable electronic device and the supplemental battery.

17. The battery case of claim 1 wherein the supplemental battery is configured to charge an original battery of the portable electronic device when the portable electronic device in placed in the recessed space and the first portion is engaged with the second portion.

18. The battery case of claim 1, wherein the first portion and the second portion are engaged by sliding a flange of the first portion into a groove of the second portion.

19. The battery case of claim 1 wherein the portable electronic device is a smart phone, mobile phone, cellular phone, satellite phone, MP3 player, potable DVD player, digital camera, tablet computer, global positioning system, portable game console, or any other portable devices having the original inner connector located at an longitudinal end thereof.
